(19) United States
(12) Patent Application Publication
(10) Pub. No.: US 2015/0323741 A1
(43) Pub. Date: Nov. 12, 2015

(54) Optical Fiber End Face Processing Method, Optical Fiber End Face and Processing Apparatus

(71) Applicant: SUNSEA TELECOMMUNICATIONS CO., LTD., ShenZhen (CN)

(72) Inventors: Qiyue WANG, ShenZhen (CN); Cheng ZHONG, ShenZhen (CN); Xinjun CHEN, ShenZhen (CN)

(21) Appl. No.: 14/651,256

(22) PCT Filed: Dec. 14, 2012
(86) PCT No.: PCT/CN2012/086634

§ 371 Date: Jun. 11, 2015

(51) Int. Cl. G02B 6/255; G02B 6/26; G02B 6/25

(52) U.S. Cl. CPC G02B 6/2551; G02B 6/25; G02B 6/2552; G02B 6/262; G02B 6/2553

(57) ABSTRACT

An optical fiber end face processing method, an optical fiber end face formed using the processing method and a processing apparatus used in the optical fiber end face processing method. The processing method comprises: chamfering and fusion splicing: providing a heat source to an optical fiber end face (3) formed in cutting of an optical fiber to perform chamfering and fusion splicing on an outer edge (33) of the optical fiber end face (3); end face forming: enabling the outer edge (33) of the optical fiber end face (3) to form a cambered surface or a chamfering inclined surface through a surface tension effect of a liquid-state part of the optical fiber at an end of the optical fiber. A processing part of the optical fiber end face processing method has a small area. The processed optical fiber end face is smooth and flat, facilitates butting, and prevents a fiber core and a near end face thereof from being hot melted and bonded, thus keeping a cross-sectional shape of the processing part and improving an optical fiber butting transmission indicator.

### FIELD OF THE INVENTION

The invention relates to the field of optical fibers, and more particularly to a method for improving an end face of an optical fiber, an improved end face of an optical fiber resulting therefrom, and a processing apparatus used therefor.

### BACKGROUND OF THE INVENTION

To ensure high optical transmission efficiency, the connection between optical fibers or between an optical fiber and an optical fiber receiving component requires aligning the fiber cores. Currently, typical processing methods for an end face of an optical fiber include cutting and polishing. The cutting method employs a cutting tool to cut an optical fiber to produce an even end face. The polishing method employs a polishing machine to polish the end face of an optical fiber through multi-operation to produce a smooth flat surface, inclined surface, or cambered surface. In contrast, the cutting method is relatively simple, with a flat surface produced. And, because the fiber core is brittle, after cutting, the end faces of the fiber core and the cladding in the vicinity of the fiber core are even. However, flaws such as sharp point, bevel angle, burring, and cracking may occur on the edge of the end face far away from the fiber core. Although the end faces formed by the polishing method have reliable physical contact, good connection, high stability, the operation procedure is complex and involves high costs.

Chinese Patent Publication No. CN 102346275 A discloses a processing method for an end face of an optical fiber. The method employs a thermal source to heat the end of the optical fiber so that the temperature therein instantly reaches or exceeds the melting point of the fiber material. Thereafter, the end face of the optical fiber presents a spherical surface or a quasi-spherical surface due to the surface tension effect of liquefied fibers at the end of the optical fiber, thereby facilitating the physical contact of the end faces of the optical fibers upon butting. The method employs the thermal source to thermally melt the end face of the optical fiber, and thus solves the adverse effect brought about by the refractive index matching liquid, ensures the reliable physical contact of the end faces of the optical fibers upon butting, almost presents the same effect as the polishing method.

However, the formation of the spherical surface or the quasi-spherical surface simply relies on the surface tension of the liquefied fibers at the end of the optical fiber, which is very difficult to achieve, and the fusion splice affects a large fiber area and has a complex process. Specifically, the fusion splice inevitably acts on the end face of the fiber core. The fiber core of the optical fiber is brittle and tends to deform, if the fusion splice directly acts on the fiber core, the fiber core will protrude outsides. Worse, the fiber core may fuse with the cladding whereby changing the refractive index thereof, thus adversely affecting the optical transmission efficiency. In addition, the fusion makes the fiber alignment more difficult, reduces the alignment precision. In summary, the fiber core as well as surroundings thereof is prohibited from the fusion splice.

### SUMMARY OF THE INVENTION

In view of the above-described problems, it is one objective of the invention to provide a method for improving an end face of an optical fiber, an improved end face of an optical fiber resulting therefrom, and a processing apparatus used therefor. The method targets at only a small part of an optical fiber, and is easy to operate. The obtained end face of the optical fiber from the method is smooth and even, upon butting, it is easy to align the fiber cores. The processing apparatus comprises a detection device configured to inspect quality of the end face of the optical fiber and a distance between the end face of the optical fiber and the thermal source, thereby improving the processing accuracy and flexibility.

The above objectives are achieved according to the following technical solutions.

To achieve the above objective, in accordance with one embodiment of the invention, there is provided a method for improving an end face of an optical fiber, the method comprising:
step A, chamfering and fusion splicing: providing a thermal source to an end face of an optical fiber resulting from fiber cutting, and chamfering and fusion splicing an outer edge of the end face of the optical fiber; and
step B, shaping the end face: allowing the outer edge of the end face of the optical fiber to present a cambered surface or a chamfered inclined surface as a result of surface tension effect of liquefied fibers at one end of the optical fiber.

In a class of this embodiment, in step A, during the chamfering and fusion splicing, an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area.

In a class of this embodiment, prior to step A, the method further comprises step A1, step A1 comprising cutting the optical fiber to form the end face of the optical fiber.

In a class of this embodiment, after step A1 and prior to step A, the method further comprises distance positioning; the distance positioning comprises moving the end face of the optical fiber within a distance adapted for fusion splice.

In a class of this embodiment, after step A1 and prior to step A, the method further comprises quality inspection; the quality inspection comprises inspecting quality of the end face of the optical fiber after the fiber cutting.

In a class of this embodiment, the quality inspection comprises slope inspection and flaw inspection; for the slope inspection, after the fiber cutting, when an included angle between the end face of the optical fiber and a central axis of the fiber core is less than θ, then return to step A1; for the flaw inspection, an intersection point of the central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, return to step A1.

In a class of this embodiment, in the process of slope inspection, the included angle θ between the end face of the optical fiber and the central axis of the fiber core is between 80° and 90°.

In a class of this embodiment, following step B, the method further comprises step B1: performing quality inspection on the formed end face; an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, return to step A1; when the flaw only occurs in the second area, then return to step A; when no flaw occurs, terminate the operation.

In a class of this embodiment, in step A, the thermal source is produced by electric arc, laser, or flame.

The invention further provides an improved end face of an optical fiber obtained by the method.

In another aspect, the invention further provides an apparatus for improving an end face of an optical fiber using the method, the apparatus comprising a discharge device configured for fusion splice, and a detection device configured to inspect quality of the end face of the optical fiber and a distance between the end face of the optical fiber and the thermal source; the discharge device comprising a discharging pole, and the detection device comprising a camera and distance measuring equipment.

Advantages of the invention are summarized as follows. In this invention, the chamfering and fusion splicing only targets at the outer edge of the cladding of the optical fiber, so that the thermal treatment involves a small area, and the operation is convenient, thereby ensuring the formation of the desired shape of the end face of the optical fiber. In addition, the end face in the vicinity of the fiber core can be effectively prevented from fusion splicing and fusing, thereby ensuring the cross section of the end face in the vicinity of the fiber core remains intact. The outer edge of the end face of the optical fiber is a cambered surface or a chamfered inclined surface, and is lower than the end face of the optical fiber, which facilitates the butting of the end faces of the fiber cores thereby ensuring the reliable physical contact and enhancing the optical transmission efficiency. Furthermore, the method employs a detection device to real time detect the cutting quality of the end face of the optical fiber, which is favorable to the determination for the next step to direct thermal treatment or to return for re-cutting. Also, the detection device can effectively detect and control the distance between the end face of the optical fiber and the thermal source, so as to enable the end face of the optical fiber to move within the effective fusion splice range, which facilitates the subsequent chamfering and fusion splicing, thereby improving the treatment accuracy and efficiency of the end face of the optical fiber.

### BRIEF DESCRIPTION OF THE DRAWINGS

FIG. 1 is a sectional view of an optical fiber of the invention after being cut;

FIG. 2a is a schematic diagram showing different areas of an end face of an optical fiber in FIG. 1;

FIG. 2b is a schematic diagram showing different quality areas of an end face of an optical fiber in FIG. 1;

FIG. 3 is a schematic diagram of fusion splicing of an end face of an optical fiber in FIG. 1;

FIG. 4 is a state diagram of fusion splicing of an end face of an optical fiber in FIG. 1;

FIG. 5a is a schematic diagram of an end face of an optical fiber obtained by a method according to one embodiment of the invention;

FIG. 5b is another schematic diagram of an end face of an optical fiber obtained by a method according to one embodiment of the invention; and

FIG. 6 is a schematic diagram showing butting of end faces of optical fibers in FIG. 5 after fusion splicing.

In the drawings, the following reference number are used: 1. Cladding; 2. Fiber core; 3. End face of optical fiber; 4. Circle; 5. First area; 6. Second area; 7. Thermal treatment site; 8. Electric pole; 31. Flaw; 32. End face of fiber core; 33. Outer edge of end face of optical fiber; 34. End face of cladding.

### DETAILED DESCRIPTION OF THE EMBODIMENTS

Detailed description of the invention will be given below in conjunction with accompanying drawings.

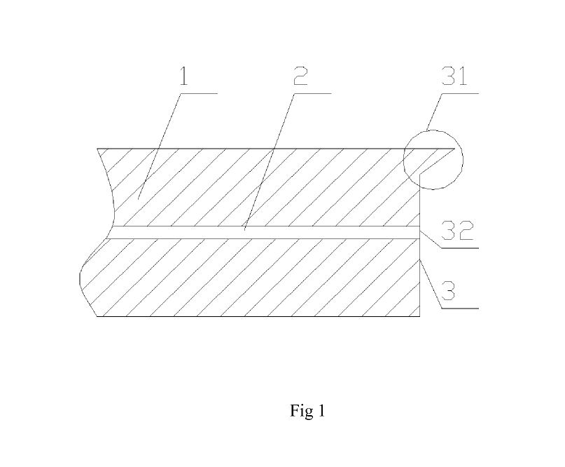

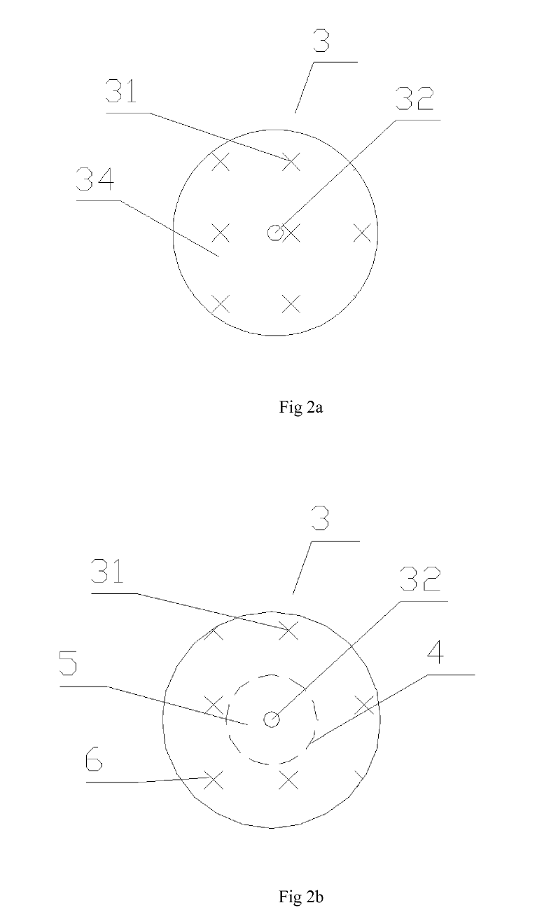

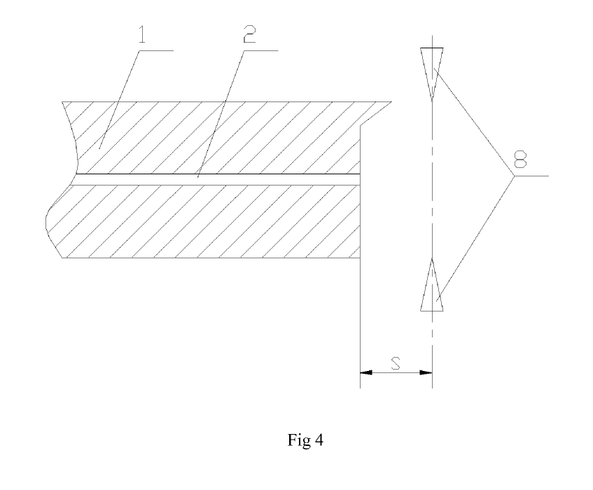

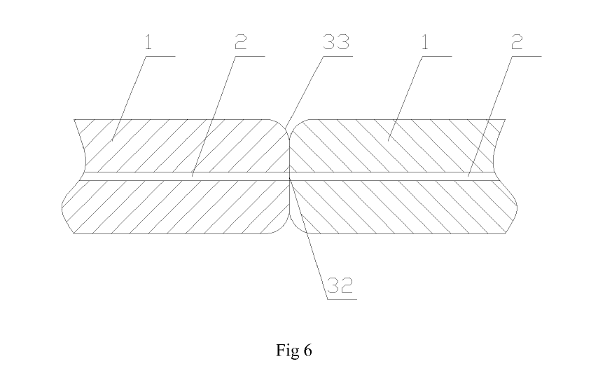

As shown in FIGS. 1-6, a method for improving an end face of an optical fiber comprises:

step A, chamfering and fusion splicing: providing a thermal source for an end face 3 of an optical fiber resulting from fiber cutting, and chamfering and fusion splicing an outer edge of the end face 3 of the optical fiber; and

step B, shaping the end face: allowing the outer edge 33 of the end face of the optical fiber to present a cambered surface or a chamfered inclined surface as a result of surface tension of liquefied fibers at one end of the optical fiber.

Preferably, in this example, in the process of chamfering and fusion splicing, the outer edge 33 of the end face of the optical fiber is a chamfered inclined surface or a cambered surface.

In step A, during the chamfering and fusion splicing, take an intersection point of a central axis of the fiber core and the end face 3 of the optical fiber as a center of a circle, with a length no less than a radius of the fiber core as a radius, to draw a circle 4; area within the circle is called a first area 5, and area outside the circle and within the outer edge of the end face of the optical fiber is called a second area 6; the chamfering and fusion splicing are carried out on the second area.

Specifically, prior to step A, the method further comprises step A1, step A1 comprising cutting the optical fiber to form the end face 3 of an optical fiber.

Specifically, after step A1 and prior to step A, the method further comprises distance positioning; the distance positioning comprises moving the end face of the optical fiber within a distance adapted for fusion splice.

Specifically, after step A1 and prior to step A, the method further comprises quality inspection; the quality inspection comprises inspecting quality of the end face of the optical fiber after the fiber cutting.

Specifically, the quality inspection comprises slope inspection and flaw inspection; after the fiber cutting, when an included angle between the end face 3 of the optical fiber and a central axis of the fiber core 2 is less than θ, then return to step A1; for the flaw inspection, take an intersection point of the central axis of the fiber core 2 and the end face 3 of the optical fiber as a center of a circle, with a length no less than a radius of the fiber core 2 as a radius, to draw a circle 4; area within the circle is called a first area 5, and area outside the circle and within the outer edge of the end face of the optical fiber is called a second area 6; the chamfering and fusion splicing are carried out on the second area 6; when a flaw 31 comprising sharp point, bevel angle, burring, and cracking occurs in the first area 5, return to step A1.

Specifically, in the process of slope inspection, the included angle θ between the end face of the optical fiber and the central axis of the fiber core is between 80° and 90°.

Specifically, following step B, the method further comprises step B1: performing quality inspection on the formed end face; take an intersection point of a central axis of the fiber core and the end face 3 of the optical fiber as a center of a circle, with a length no less than a radius of the fiber core as a radius, to draw a circle 4; area within the circle is called a first area 5, and area outside the circle and within the outer edge of the end face of the optical fiber is called a second area 6; the chamfering and fusion splicing are carried out on the second area; when a flaw 31 comprising sharp point, bevel angle, burring, and cracking occurs in the first area 5, return to step A1; when the flaw 31 only occurs in the second area, then return to step A; when no flaw occurs, terminate the operation.

The invention also provides an improved end face of an optical fiber obtained by the method.

The invention further provides an apparatus for improving an end face of an optical fiber using the method. The apparatus comprises a discharge device configured for fusion splice, and a detection device configured to inspect quality of the end face of the optical fiber and a distance between the end face of the optical fiber and the thermal source. The discharge device comprises a discharging pole, and the detection device comprises a camera and distance measuring equipment.

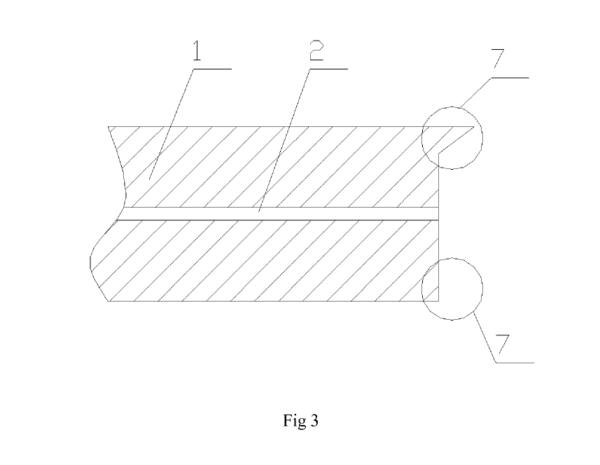

In this invention, the principle of the fusion splice is shown in FIG. 3. The end face of the optical fiber needing fusion splice is disposed within a preset distance between the end face 3 of the optical fiber and the thermal source. The sites where the flaws 31 occur on the end face of the optical fiber are the thermal treatment sites 7. A thermal source is disposed on the sites for fusion splice.

As a first preferable example, during the fusion splice of the end face of the optical fiber resulting from fiber cutting, take an intersection point of a central axis of the fiber core and the end face 3 of the optical fiber as a center of a circle, with a length no less than a radius of the fiber core as a radius, to draw a circle 4; area within the circle is called a first area 5, and area outside the circle and within the outer edge of the end face of the optical fiber is called a second area 6; no quality inspection is involved, and the chamfering and fusion splicing are carried out directly on the second area. In the process of fusion splice, only the end face 34 of the cladding is treated, which means a simple operation.

As another preferable example, prior to the fusion splice of the end face 3 of the optical fiber resulting from fiber cutting, distance measuring equipment of the detection device is employed to position the end face of the optical fiber. The end face of the optical fiber is shifted and positioned within a distance adapted for fusion splice. That is to say, the distance S between the end face of the optical fiber and the discharging pole 8 of the discharge device needs accurately measured, so as to ensure the fusion splice to proceed according to preset dimensions. On the one hand, the fiber core end face 32 remains intact, one the other hand, the flaws on the end face are melted completely, thereby ensuring the fusion splice effect and efficiency. After positioning, the quality inspection of the end face 3 of the optical fiber is achieved by the camera of the detection device:

(1) for the slope inspection, after the fiber cutting, when an included angle between the end face 3 of the optical fiber and a central axis of the fiber core 2 is less than 80°-90°, then return to step A1;

(2) for the flaw inspection, take an intersection point of the central axis of the fiber core 2 and the end face 3 of the optical fiber as a center of a circle, with a length no less than a radius of the fiber core as a radius, to draw a circle 4; area within the circle is called a first area 5, and area outside the circle 4 and within the outer edge of the end face 3 of the optical fiber is called a second area 6. Accordingly, two circumstances may occur.

One circumstance is that, flaws 31 occur in the first area 5, which means the fusion splice must be performed on the end face of the fiber core, which tends to destroy the fiber core. As a result, the optical fiber needs cutting again, followed by the quality inspection on the newly formed end face of the optical fiber.

Another circumstance is that, no flaws 31 occur in the first area 5, and then the fusion splice can be directly carried out on the end face 3 of the optical fiber. The fusion splice can be freely carried out based on the location of the flaws 31. If the flaws 31 are far away from the circle 4, the area receiving the fusion splice will be small, otherwise, the area will be large. Anyway, the fusion splice area all falls in the preset scope, and will not affect the end face of the fiber core. After the fusion splicing and end face shaping, the quality inspection is followed. The quality inspection only comprises flaw inspection but not slope inspection. The repeated inspection on the end face of the optical fiber can effectively ensure the end face of the cladding of the optical fiber remains intact after the original cutting, no fusion splicing involved in this area, and the flaws in the second area 6 have been removed, thereby ensuring the smooth connection.

Based on the results of the quality inspection on the end face, the dimensions of the optical fiber needing chambering and fusion splicing can be effectively determined, thereby avoiding unnecessary fusion splicing, and enhancing the treatment efficiency. In practice, as needed, the sequence of distance positioning and fusion splicing can be interchanged, for example, the distance positioning is first carried out, followed by the fusion splicing. The final effect is the same. Likewise, for the quality inspection, the sequence of the slope inspection and the flaw inspection can also be interchanged, for example, the flaw inspection is first carried out, followed by the slope inspection. When the two inspections both satisfy the requirement, the fusion splicing is performed.

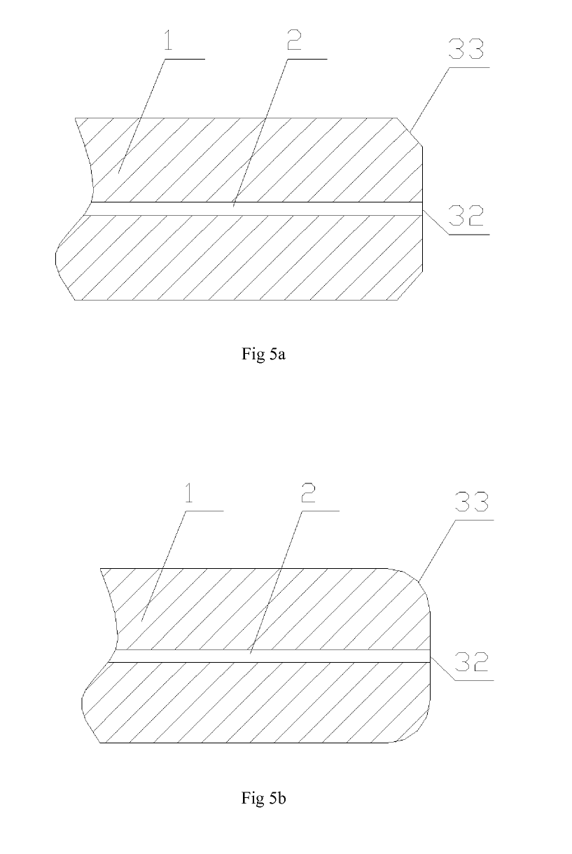

After the abovementioned treatment, the outer edge 33 of the end face of the optical fiber presents a cambered surface or a chamfered inclined surface, and the end face of the fiber core of the optical fiber is just the cross section resulting from cutting, no fusion splicing involved, as shown in FIG. 5. The dimensions of the cambered surface or the chamfered inclined surface are determined by the area of the flaws 31. Thus, the fusion splice is much flexible, and the connection area of the optical fiber is as small as possible. When connecting optical fibers, the alignment of the fiber core 2 can be improved by aligning the end faces of the fiber cores of the optical fibers, thereby enhancing the optical transmission rate.

In this invention, the fusion splice only targets at the outer edge of the cladding 1 of the fiber core 2 of the optical fiber. In another word, the fusion splice is only carried out on the end face 34 of the cladding of the optical fiber. The fusion splice temperature is no lower than the melting point of the cladding material, so that the flaw areas on the outer edge of the cladding 1 are melted rapidly. In addition, the melting time is accurately controlled to ensure the formation of desired shapes. The method of the invention enables the fusion splice area of the optical fiber to be small as possibly. Thus, the method is convenient for operation, the shape of the end face of the optical fiber can be effectively controlled, the end face in the vicinity of the fiber core 2 can be effectively prevented from fusion splicing, thereby ensuring the cross section of the end face in the vicinity of the fiber core remains intact. The method facilitates the butting of the end faces of the fiber cores thereby ensuring the reliable physical contact and enhancing the optical transmission rate. In addition, the method employs a detection device to real time detect the cutting quality of the end face of the optical fiber thereby determining to next step for fusion splicing or to return for repeated cutting. Also, the detection device can effectively detect and control the distance between the end face of the optical fiber and the thermal source, so as to enable the end face of the optical fiber to move within the effective fusion splice scope, which facilitates the subsequent chamfering and fusion splicing, thereby improving the treatment accuracy and efficiency of the end face of the optical fiber.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

1. A method for improving an end face of an optical fiber, the method comprising:
step A, chamfering and fusion splicing: providing a thermal source to an end face of an optical fiber resulting from fiber cutting, and chamfering and fusion splicing an outer edge of the end face of the optical fiber; and
step B, shaping the end face: allowing the outer edge of the end face of the optical fiber to present a cambered surface or a chamfered inclined surface as a result of surface tension effect of liquefied fibers at one end of the optical fiber.

2. The method of claim 1, wherein in step A, during the chamfering and fusion splicing, an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area.

3. The method of claim 1, wherein prior to step A, the method further comprises step A1, step A1 comprising cutting the optical fiber to form the end face of the optical fiber.

4. The method of claim 3, wherein after step A1 and prior to step A, the method further comprises distance positioning; the distance positioning comprises moving the end face of the optical fiber within a distance adapted for fusion splice.

5. The method of claim 4, wherein after step A1 and prior to step A, the method further comprises quality inspection; the quality inspection comprises inspecting quality of the end face of the optical fiber after the fiber cutting.

6. The method of claim 5, wherein the quality inspection comprises slope inspection and flaw inspection; for the slope inspection, after the fiber cutting, when an included angle between the end face of the optical fiber and a central axis of the fiber core is less than θ, then return to step A1; for the flaw inspection, an intersection point of the central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, return to step A1.

7. The method of claim 6, wherein in the process of slope inspection, the included angle θ between the end face of the optical fiber and the central axis of the fiber core is between 80° and 90°.

8. The method of claim 1, wherein following step B, the method further comprises step B1: performing quality inspection on the formed end face; an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, return to step A1; when the flaw only occurs in the second area, then return to step A; when no flaw occurs, terminate the operation.

9. An optical fiber end face obtained by the method of claim 1.

10. An apparatus for improving an optical fiber end face using the method of claim 1, the apparatus comprising a discharge device configured for fusion splice, and a detection device configured to inspect quality of the end face of the optical fiber and a distance between the end face of the optical fiber and the thermal source; the discharge device comprising a discharging pole, and the detection device comprising a camera and distance measuring equipment.

11. The apparatus of claim 10, wherein an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area.

12. The apparatus of claim 10, wherein the optical fiber end face is formed by cutting the optical fiber.

13. The apparatus of claim 10, wherein quality inspection is performed on the formed end face; an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, then cutting the fiber to form the optical fiber end face; when the flaw only occurs in the second area, then the chamfering and fusion splicing are carried out on the second area; when no flaw occurs, terminate the operation.

14. The optical fiber end face of claim 9, wherein an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area.

15. The optical fiber end face of claim 9, wherein the optical fiber end face is formed by cutting the optical fiber.

16. The optical fiber end face of claim 15, wherein the optical fiber end face is moved within a distance adapted for fusion splice.

17. The optical fiber end face of claim 16, wherein the optical fiber end face after the fiber cutting is performed quality inspection.

18. The optical fiber end face of claim 17, wherein the quality inspection comprises slope inspection and flaw inspection; for the slope inspection, after the fiber cutting, when an included angle between the end face of the optical fiber and a central axis of the fiber core is less than θ, then cutting the fiber to form the optical fiber end face; for the flaw inspection, an intersection point of the central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, then cutting the fiber to form the optical fiber end face.

19. The optical fiber end face of claim 18, wherein in the slope inspection, the included angle θ between the end face of the optical fiber and the central axis of the fiber core is between 80° and 90°.

20. The optical fiber end face of claim 9, wherein quality inspection is performed on the formed end face; an intersection point of a central axis of the fiber core and the end face of the optical fiber is employed as a center of a circle, with a length no less than a radius of the fiber core as a radius, to draw a circle; area within the circle is called a first area, and area outside the circle and within the outer edge of the end face of the optical fiber is called a second area; the chamfering and fusion splicing are carried out on the second area; when a flaw comprising sharp point, bevel angle, burring, and cracking occurs in the first area, then cutting the fiber to form the optical fiber end face; when the flaw only occurs in the second area, then the chamfering and fusion splicing are carried out on the second area; when no flaw occurs, terminate the operation.
